(19) United States
(12) Patent Application Publication
(10) Pub. No.: US 2016/0004222 A1
(43) Pub. Date: Jan. 7, 2016

(54) END LINKS FOR USE IN COUPLING WATCH STRAPS TO BASES OF WATCHES, AND RELATED METHODS

(71) Applicant: Everest Horology Products, Manchester, MO (US)

(72) Inventors: David Larry Barnes, St. Louis, MO (US); Michael Joseph DiMartini, St. Louis, MO (US)

(21) Appl. No.: 14/323,511

(22) Filed: Jul. 3, 2014

(51) Int. Cl. G04B 29/04

(52) U.S. Cl. CPC G04B 29/04

(57) ABSTRACT

A link is provided for use in a watch for coupling a watch strap to a base of the watch. The link includes a body defining an arcuate seat extending generally longitudinally along the body, and first and second ears extending generally away from the body. Each of the first and second ears defines an opening, and the opening of the first ear is substantially aligned with the opening of the second ear. The link also includes a channel defined between the first and second ears for receiving an end portion of the watch strap when coupling the watch strap to the base of the watch.

### FIELD

The present disclosure generally relates to links for use in watches and, more particularly, to end links (as part of watch strap assemblies) for use in coupling watch straps to bases of the watches, and methods related thereto.

### BACKGROUND

This section provides background information related to the present disclosure which is not necessarily prior art.

Watches are configured to be worn by users and typically have bases that include features to indicate time to the users. Straps coupled to the bases of the watches are used to secure the watches to the users' wrists.

### SUMMARY

This section provides a general summary of the disclosure, and is not a comprehensive disclosure of its full scope or all of its features.

Exemplary embodiments of the present disclosure generally relate to links for use in watches to couple watch straps to bases of the watches. In one exemplary embodiment, such a link generally includes a body defining an arcuate seat extending generally longitudinally along the body, first and second ears extending generally away from the body, and a channel defined between the first and second ears. The first and second ears each define an opening, and the opening of the first ear substantially aligns with the opening of the second ear.

Exemplary embodiments of the present disclosure also generally relate to watch strap assemblies for coupling watch straps to bases of watches. In one exemplary embodiment, a watch strap assembly generally includes a watch strap, a link configured to position at an end portion of the watch strap, and a spring bar configured to couple the watch strap to the link and the link to a base of the watch.

Exemplary embodiments of the present disclosure also generally relate to methods of coupling watch straps to watch bases using links, where the links include bodies defining arcuate seats, and first and second ears extending away from the bodies. In one exemplary embodiment, such a method generally includes positioning an end loop of a watch strap between the first and second ears of the link such that a channel defined through the end loop is aligned with openings defined in the first and second ears of the link; inserting a spring bar through the openings of the first and second ears and through the channel of the end loop to secure the watch strap to the end link; and positioning a first end of the spring bar in a first depression of the watch base, and a second end of the spring bar in a second depression of the watch base to secure the end link and the watch strap to the watch base.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of an exemplary embodiment of a watch having a link according to the present disclosure for use in coupling a watch strap to a base of the watch;

FIG. 2 is an exploded view of the watch of FIG. 1;

FIG. 3 is a perspective view of the link of the watch of FIG. 1;

FIG. 4 is a front view of the link of FIG. 3;

FIG. 5 is a back view of the link of FIG. 3;

FIG. 6 is a left side view of the link of FIG. 3;

FIG. 7 is a right side view of the link of FIG. 3;

FIG. 8 is a top view of the link of FIG. 3; and

FIG. 9 is a bottom view of the link of FIG. 3.

Corresponding reference numerals indicate corresponding parts throughout the several views of the drawings.

### DETAILED DESCRIPTION

As described above, exemplary embodiments of the present disclosure generally relate to links (e.g., end links, links included in watch strap assemblies, etc.) for watches for use in coupling watch straps (e.g., bands, etc.) to bases of the watches. In use, the watches can then be worn by users, for example, around the users' wrists via the watch straps. The watches can include any desired watches, and the bases of the watches can include any desired means for indicating time (e.g., analog means, digital means, etc.).

In some aspects, the links of the present disclosure provide improved couplings (e.g., fits, etc.) between the watch straps and the watch bases of the watches. In addition, in some aspects, the links of the present disclosure also provide desirable aesthetics to the watches (and particularly to the couplings between the watch straps and the watch bases). As such, through use of the links in the watches, the watches may be more comfortable to wear by the users and more aesthetically pleasing to the users.

In some aspects, the links of the present disclosure can also accommodate multiple different watch straps and, thus, can be used to selectively couple the multiple different watch straps to the watches as desired by the users. As an example, the links, when used in the watches, allow the users to interchange watch straps with particular watch bases, or even use particular watch straps with various different watch bases (e.g., as desired by the users for comfort, style, durability, etc.).

With that said, in some embodiments, the links may be included with the watches when the watches are originally made (i.e., may be included as original equipment manufacturer (OEM) watch strap assemblies). Here, the links can then be used to facilitate installation of replacement watch straps to the bases of the watches (i.e., to replace the OEM watch straps with replacement watch straps as desired by the users). In other embodiments, the links may be subsequently installed to the bases of the watches after the watches are purchased (e.g., as aftermarket components, etc.). Here, the links can then be used with the OEM watch straps to improve the fit between the OEM watch straps and the bases of the watches. Or, the links can be used to facilitate installation of replacement watch straps to the bases of the watches.

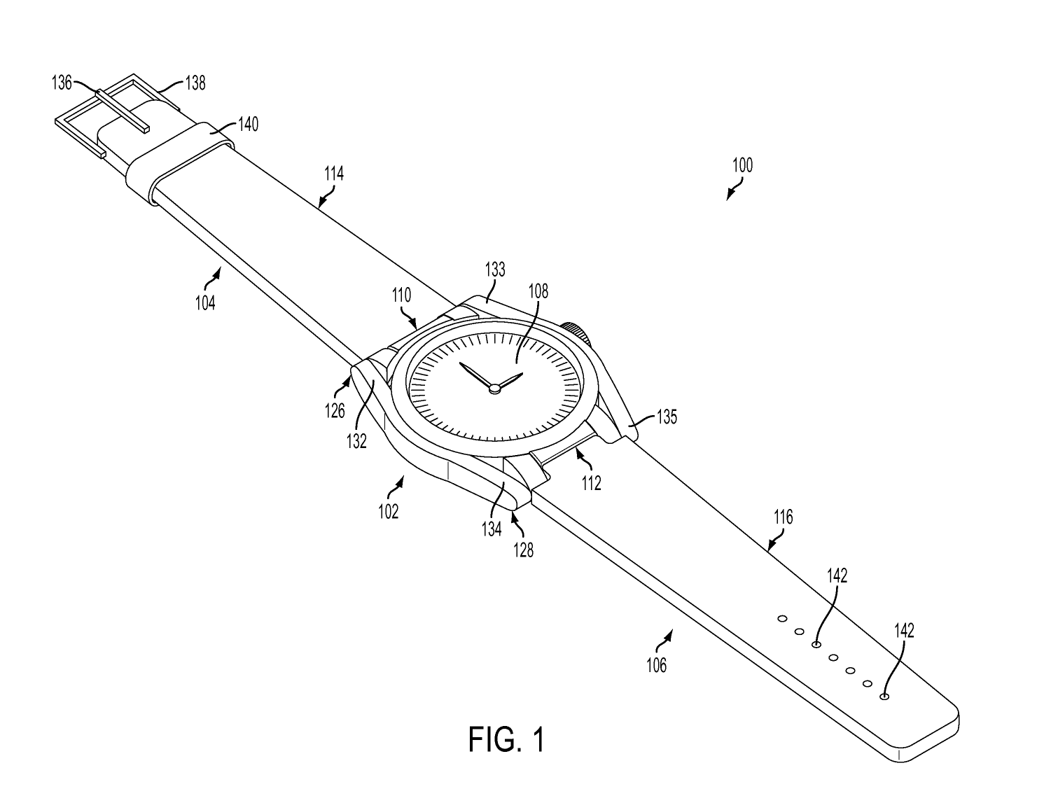

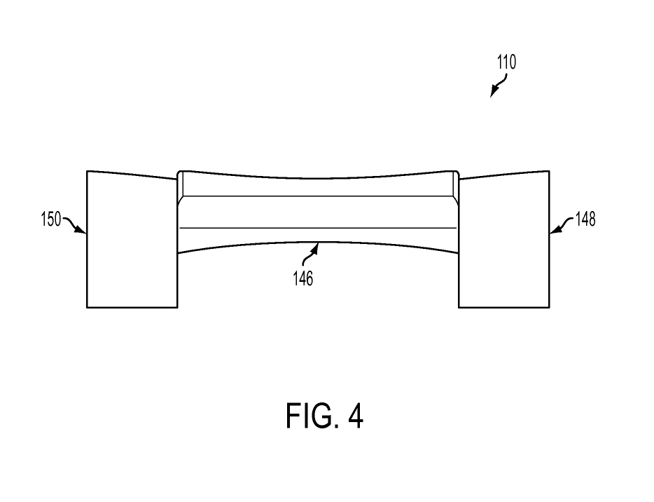

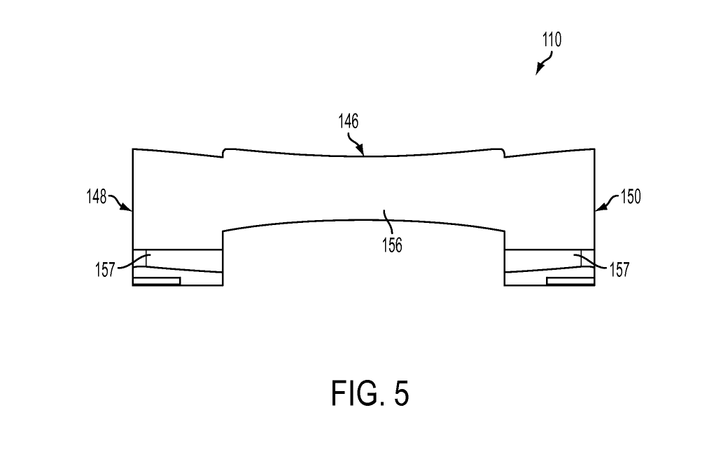

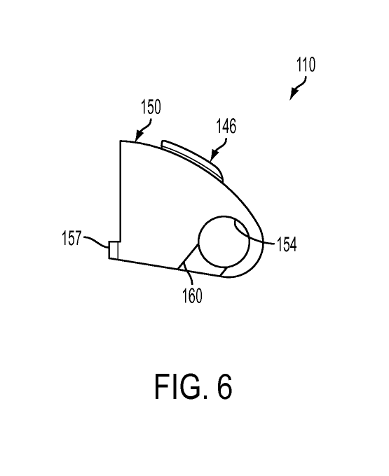

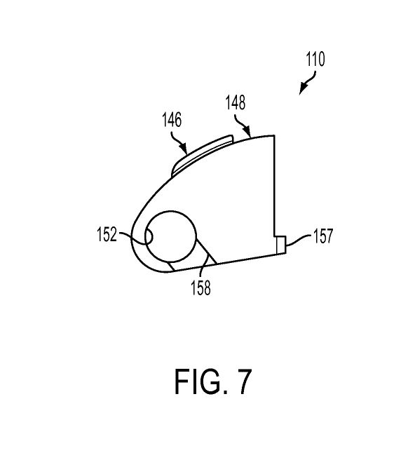

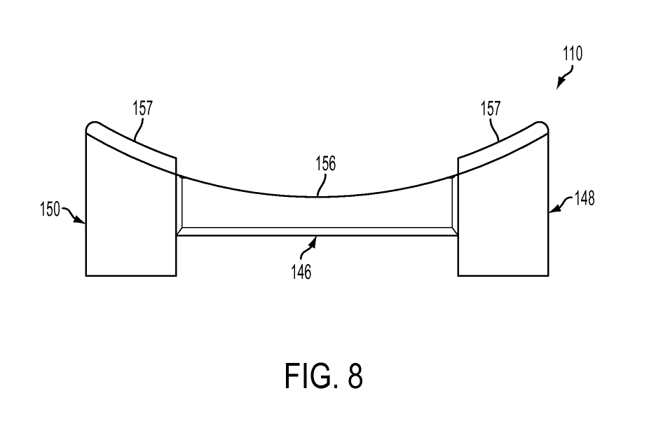

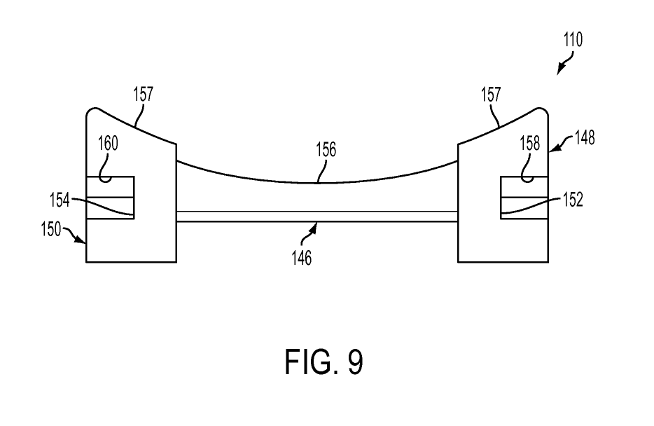

With reference now to the drawings, FIGS. 1-9 illustrate an exemplary embodiment of a watch 100, and components thereof, having one or more aspects of the present disclosure. The watch 100 can be used to provide time to a user, and can be worn by the user for convenience in accessing the watch 100 to view the time.

The illustrated watch 100 generally includes a base 102 and first and second watch strap assemblies 104, 106 coupled to the base 102. While not shown, additional components may also be associated with the watch 100 without departing from the scope of the present disclosure.

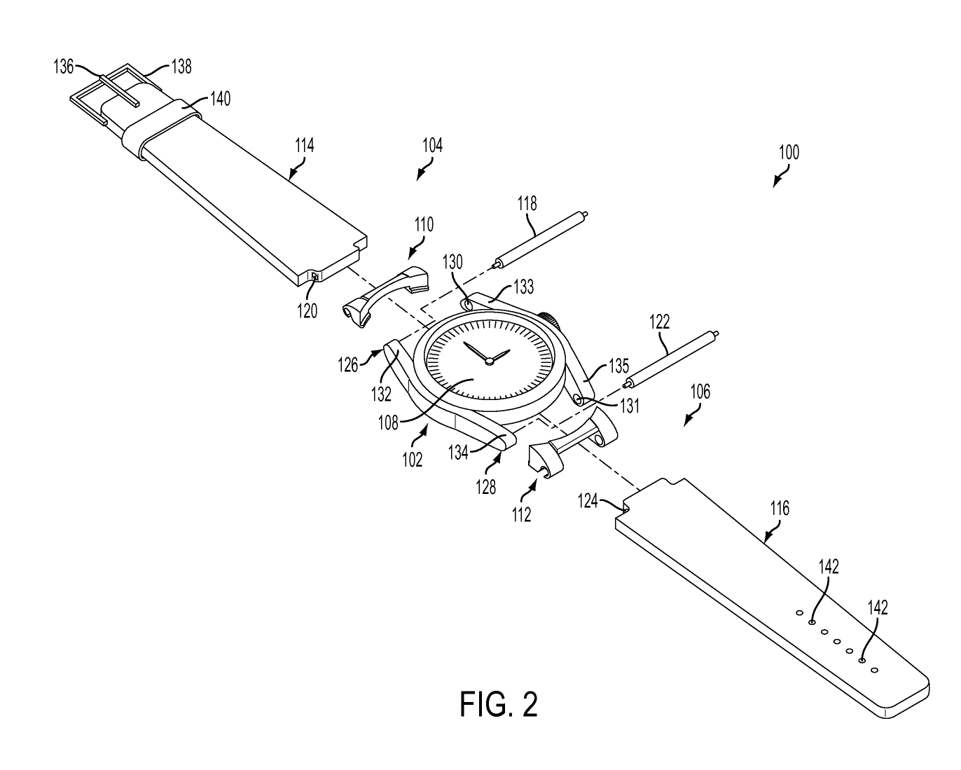

As shown in FIGS. 1 and 2, the base 102 of the watch 100 generally includes a face portion 108 having a time feature for displaying the time to the user. The face portion 108 may be integral with the base 102, or may be a separate component coupled thereto (e.g., such that the base 102 defines a general shell for receiving the face portion 108 within the shell, etc.). In the illustrated embodiment, the time feature of the face portion 108 includes an analog clock having a clock face. In other embodiments, however, the time feature may include a digital clock, or may include combinations of analog clocks and digital clocks, etc. In addition, the base 102 of the illustrated watch 100 includes a generally rounded shape, but could have other shapes within the scope of the present disclosure (e.g., square shapes, rectangular shapes, triangular shapes, octagon shapes, oval shapes, etc.). Further, the base 102 and/or face portion 108 of the watch 100 may be constructed from any suitable material including, for example (and without limitation), metals (e.g., stainless steel, gold, titanium, etc.), plastics, combinations thereof, etc.

Each of the watch strap assemblies 104, 106 of the illustrated watch 100 includes a link (link 110 of the first watch strap assembly 104, and link 112 of the second watch strap assembly 106) and a watch strap (watch strap 114 of the first watch strap assembly 104, and watch strap 116 of the second watch strap assembly 106). In the first watch strap assembly 104, the watch strap 114 is coupled to the link 110 by a first spring bar 118 that extends through a loop opening 120 (or loop channel) in an end portion of the watch strap 114. Similarly, in the second watch strap assembly 106, the watch strap 116 is coupled to the link 112 by a second spring bar 122 (which is substantially the same as the first spring bar 118). And again, the second spring bar 122 extends through a loop opening 124 (or loop channel) in an end portion of the second watch strap 116 to thereby couple the watch strap 116 to the link 112. In the illustrated embodiment, the links 110, 112 are coupled to end portions of the watch straps 114, 116 and, thus, may be viewed as end links. In other embodiments, however, the links 110, 112 may be coupled to other portions of the watch straps 114, 116, for example, portions located away from end portions of the watch straps 114, 116, etc.

The links 110, 112 of the watch strap assemblies 104, 106 help couple the watch straps 114, 116 to the base 102 of the watch 100 (FIG. 1). In particular, the links 110, 112 help couple the watch straps 114, 116 to mounts 126, 128 of the base 102 located generally along a perimeter (or outer circumference, etc.) of the base 102. For example, the link 110 and watch strap 114 of the first watch strap assembly 104 couple to the base 102 at first mount 126 (located on a generally left side of the base 102, etc.). And, the link 112 and watch strap 116 of the second watch strap assembly 106 couple to the base 102 at second mount 128 (located on a generally right side of the base 102, etc.). The spring bars 118, 122, coupling the watch straps 114, 116 to the links 110, 112, are then used to also secure the links 110, 112 and the watch straps 114, 116 to the base 102 via the mounts 126, 128. In so doing, the spring bars 118, 122 are configured to compress in a longitudinal direction to allow end portions of the spring bars 118, 122 to be inserted into openings (e.g., depressions, etc.) of arms 132-135 of the mounts 126, 128 (or, conversely, removed from the openings when desired to remove the watch strap assemblies 104, 106 from the base 102). In FIG. 2, only openings 130, 131 in arms 133, 135 are visible. But it should be appreciated that arms 132, 134 include similar openings. As such, the spring bars 118, 122 simultaneously couple (e.g., secure, etc.) the watch straps 114, 116 to the links 110, 112, and the watch straps 114, 116 and the links 110, 112 to the base 102.

With continued reference to FIGS. 1 and 2 (and as best shown in FIG. 1), the illustrated links 110, 112 couple to the base 102 of the watch 100 (via the mounts 126, 128) in substantially flush contact with the perimeter of the base 102. As such, the links 110, 112 closely fit against the base 102 (e.g., at least partially in contact with the base 102, etc.). As can be appreciated (and as can be seen in FIG. 1), this coupling, fit, etc. provides a desirable aesthetic to the watch 100, as a design of the watch 100 flows from the watch strap 114, across the base 102, to the watch strap 116 without gaps, voids, or spacings, etc. interrupting the flow. In addition, the illustrated links 110, 112 are sized to position generally in line with an upper surface of the base 102 so that, when viewed in profile, the links 110, 112 again provide, aesthetically, a generally seamless flow from the upper surface of the base 102, across the links 110, 112, to the watch straps 114, 116. Further, the close coupling of the links 110, 112 with the perimeter of the base 102 results in little or no relative movement between the links 110, 112 and the base 102 during use of the watch 100. This, in turn, provides an improved and more durable coupling, fit, etc. between the watch straps 114, 116 and the base 102, as the links 110, 112 (with the watch straps 114, 116 coupled thereto) provide a relatively tight and secure fit of the watch straps 114, 116 to the mounts 126, 128. As such, the illustrated watch 100, through use of the links 110, 112, is not only more aesthetically pleasing to the user but is also more comfortable to the user wearing the watch 100, for example, on the user's wrist.

In use of the illustrated watch 100 by the user, the watch straps 114, 116 are configured to couple together, at end portions generally opposite the links 110, 112, to secure the watch 100 to the wrist of the user. In the illustrated embodiment, the first watch strap 114 includes a clasp 136, a buckle 138, and a keeper 140. And, the second watch strap 116 defines multiple holes 142. To secure the watch 100 to the wrist of the user, the clasp 136 of the first watch strap 114 is positioned within a select hole 142 of the second watch strap 116, and the end portion of the second watch strap 116 is then positioned through the buckle 138 and the keeper 140. With that said, the watch straps 114, 116 may include other couplings (e.g., other than clasps, buckles, etc.) for use in securing the watch 100 to the wrist of the user (e.g., friction-based couplings, hook-and-loop-based couplings, etc.).

In addition, it should be appreciated that the watch straps 114, 116 of the illustrated watch 100 may be made of any suitable material including, for example, metal, leather, rubber, plastic, elastic material, combinations thereof, etc. Further, the watch straps 114, 116 may be formed as a single, unitary structure (as shown in FIGS. 1 and 2) or they may be constructed from individual components (e.g., individual links, etc.) coupled together. Moreover, while the illustrated watch 100 includes two separate watch straps 114, 116, in other embodiments watches may include a single watch strap (e.g., having a deployment clasp, etc.) for use in securing the watches to wrists of users. Here, the links 110, 112 may be coupled to end portions of the single straps for use in coupling the watch straps to bases of the watches.

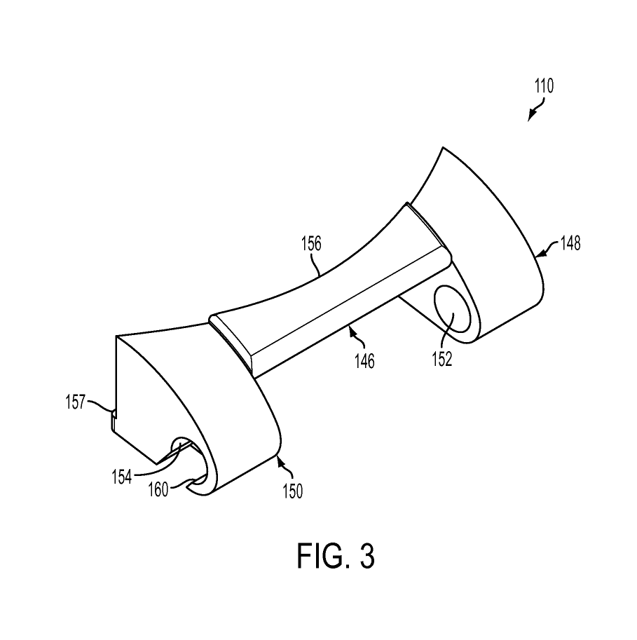

With additional reference now to FIGS. 3-9, the link 110 of the first watch strap assembly 104 of the watch 100 will be described in more detail. It should be appreciated that the link 110 is substantially the same as the link 112 of the second watch strap assembly 106, and that the following description of the link 110 therefore also applies to the link 112. Further, it should be appreciated that the links 110, 112 could be interchanged (i.e., the first link 110 could be used with the second watch strap 116, and the second link 112 could be used with the first watch strap 114). However, such similarity and interchangeability is not required in the present disclosure, as the first link 110 could instead be particularly formed for use with the first watch strap 114 and the second link 112 could be particularly formed for use with the second watch strap 116, etc.

As shown in FIGS. 3-9, the link 110 generally includes a body 146 and first and second ears 148, 150 extending generally away from the body 146. The first ear 148 is located generally toward a first longitudinal end of the body 146, and the second ear 150 is located generally toward a second longitudinal end of the body 146. However, the ears 148, 150 may be located at different locations along the body 146 as desired, for example, at locations generally inward of the longitudinal ends, etc. And although the illustrated link 110 includes two ears 148, 150, other embodiments of links may include more than or fewer than two ears.

Also in the illustrated embodiment, the ears 148, 150 of the link 110 are generally arch shaped, but could be shaped differently as desired (e.g., one or more of the ears 148, 150 could have a rectangular shape, a triangular shape, a square shape, etc.). In addition in the illustrated embodiment, the ears 148, 150 are integrally formed with the body 146 (such that the link 110 comprises a unitary construction), but could alternatively be formed separately from the body 146 and coupled thereto. Further, the body 146 and the ears 148, 150 of the link 110 may be formed from any suitable material including, for example, metallic material (e.g., stainless steel, gold, platinum, combinations thereof, etc.), plastic material, combinations thereof, etc. Moreover, different portions of the link 110 may be formed from different materials, as desired (e.g., the ears 148, 150 may be formed from plastic material and the body 146 may be formed from metallic material, etc.).

When coupling the watch strap 114 to the link 110, the end portion of the watch strap 114 (having the loop opening 120) is positioned between the first and second ears 148, 150 of the link 110, and the spring bar 118 is inserted, received, etc. through openings 152, 154 of the ears 148, 150 and through the loop opening 120 of the watch strap 114. In the illustrated embodiment, the opening 152 of the first ear 148 generally aligns with the opening 154 of the second ear 150 (e.g., a longitudinal axis of the opening 152 of the first ear 148 generally coincides with a longitudinal axis of the opening 154 of the second ear 150, etc.). And, when the end portion of the watch strap 114 is positioned between the first and second ears 148, 150, the loop opening 120 of the watch strap 114 generally aligns with the openings 152, 154 of the ears 148, 150. As such, the spring bar 118 can be easily received through the openings 152, 154 of the ears 148, 150 and through the loop opening 120 of the watch strap 114 to thereby couple the watch strap 114 to the link 110.

The openings 152, 154 of the first and second ears 148, 150 also generally align with the openings 130, 131 defined in the arms 132, 133 of the mount 126 of the base 102, when the link 110 is positioned between the arms 132, 133 (and when the link 110 is positioned in substantially flush contact with the base 102). Thus, as described above, the spring bar 118 can easily extend through the openings 152, 154 of the first and second ears 148, 150 and through the opening 120 of the watch strap 114, and the end portions of the spring bar 118 can then be positioned, received, etc. in the openings 130, 131 of the arms 132, 133 to thereby couple the link 110 and the watch strap 114 to the base 102. In particular in the illustrated watch 100, one end portion of the spring bar 118 is received in the opening 130 of the first arm 132 of the mount 126, and the other end portion of the spring bar 118 is received in the opening 131 of the second arm 133 of the mount 126.

In the illustrated embodiment, the first and second ears 148, 150 of the link 110 can be viewed as defining a channel therebetween. And, when coupling the watch strap 114 to the link 110, the end portion of the watch strap 114 can be viewed as being received in the channel. A length of the channel (i.e., a spacing between the first and second ears 148, 150) generally corresponds to a width of the end portion of the watch strap 114 having the loop opening 120. This provides a generally tight fit between the watch strap 114 and the link 110, which in turn helps inhibits relative movement between the watch strap 114 and the link 110. This fit may also provide a more durable connection between the watch strap 114 and the link 110, as well as help facilitate the aesthetically pleasing look of the watch 100 described above. In addition, a depth of the channel (e.g., as defined by a length of the arms 132, 133 of the mount 126, etc.) generally corresponds to a depth of the end portion of the watch strap 114 having the loop opening 120. This can help automatically align the loop opening 120 of the watch strap 114 with the openings 152, 154 of the ears 148, 150 of the link 110 to facilitate easy positioning of the spring bar 118 through the aligned openings 120, 152, 154. Further, the positioning of the ears 148, 150 on opposite sides of the channel can help inhibit the watch strap 114 from inadvertently moving off the spring bar 118, for example, when the watch 100 is positioned on the wrist of the user, etc.

With continued reference to FIGS. 3-9, the body 146 of the link 110 defines an arcuate seat 156 that extends generally longitudinally along the body 146. The seat 156 is shaped to generally match the perimeter of the base 102. This helps facilitate the close fit (or match, etc.) between the link 110 and the base 102 when the link 110 is coupled to the base 102, as described above (and as also shown in FIG. 1). As such, when coupling the link 110 to the base 102 of the watch 100, the arcuate seat 156 is aligned with the perimeter portion of the base 102 (and tab portions 157 may position generally under the base 102) for facilitating the generally close fit, flush fit, etc. With that said, the seat 156 could define other shapes within the scope of the present disclosure, for example, to facilitate a match of the seat 156 with a base of a watch having a different shape than illustrated herein. As such, it should be appreciated that the shape of the seat 156 can be tailored, as desired, to match any particular shape of a base of a watch to facilitate the close fit. Further, in other embodiments of watches, links may be included that are configured to be only substantially flush with perimeter portions of bases of the watches along portions of the links, or to be not flush at all with perimeter portions of bases of the watches along any portions of the links.

In addition, it should be appreciated that the body 146 of the link 110 can have any desired size, for example, that allows positioning the link 110 between the arms 132, 133 of the mount 126 (for use in coupling the watch strap assembly 104 to the base 102 of the watch 100). As an example, the illustrated link 110 has a length (in a longitudinal direction of the link 110) (and without limitation) of about twenty millimeters, which in the illustrated embodiment generally corresponds to a distance between the arms 132, 133 of the mount 126. Further, it is contemplated that a thickness of the link 110 will generally correspond to a length of the arms 132, 133 of the first mount 126, and that a height of the link 110 will generally correspond to a thickness of the base 102. As can be appreciated, these features can help provide the flush fit of the link 110 with the base 102 of the watch 100 (along the perimeter of the base 102), as well as the aesthetically pleasing look of the watch 100 (and link 110 coupled thereto) discussed above.

Also in the illustrated embodiment, the ears 148, 150 of the link 110 define access channels 158, 160. The access channels 158, 160 allow the user to access the end portions of the spring bar 118 (for inserting or removing end portions of the spring bar 118 to or from the openings 130, 131 of the arms 132, 133 of the mount 126) when installing and/or removing the watch strap 114 to and/or from the base 102 of the watch 100. For example, the access channels 158, 160 may allow a tool to be inserted generally into the openings 152, 154 of the ears 148, 150 to operate the spring bar 118 when the spring bar 118 is positioned through the openings 152, 154 of the ears 148, 150 and the loop opening 120 of the watch strap 114. As such, the user can easily compress the spring bar 118 to insert or remove the end portions into/from the openings 130, 131 of the arms 132, 133 of the mount 126. In the illustrated embodiment, the access channels 158, 160 are located toward longitudinal ends of the body 146 of the link 110, in a generally rearward side portion of the link 110, and extend generally transverse to the longitudinal axes of the openings 152, 154 of the ears 148, 150. However, the access channels 158, 160 could be shaped and/or located differently within the scope of the present disclosure.

With that said, it should be appreciated that the links 110, 112 may be included with the watch 100 when the watch 100 is originally made (i.e., as part of the watch strap assemblies 104, 106 which may be OEM watch strap assemblies). As described, the links 110, 112 can then be used by the user to facilitate installation of replacement watch straps to the base 102 of the watch 100 as desired (i.e., to replace the OEM watch straps 114, 116 with other watch straps that may be more desirable to the user).

Alternatively, the links 110, 112 may be installed to the watch 100 after the watch 100 is originally made (e.g., as aftermarket components, etc.). Here, the links 110, 112 can then be used by the user to improve the fit of the watch straps 114, 116 (which may be OEM watch straps) to the base 102 of the watch 100. Or, the links 110, 112 can be used to facilitate installation of replacement watch straps to the base 102 of the watch 100 (and, in so doing, may be actually included with the replacement watch straps (e.g., as replacement watch strap assemblies, etc.) to facilitate such installation of the replacement watch straps to the base 102 of the watch 100). Or, the links 110, 112 can even be used to facilitate installation of the watch straps 114, 116 to a base of another watch.

Exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that exemplary embodiments may be embodied in many different forms, and that neither should be construed to limit the scope of the disclosure. In some exemplary embodiments, well-known processes, well-known device structures, and well-known technologies are not described in detail. In addition, advantages and improvements that may be achieved with one or more exemplary embodiments of the present disclosure are provided for purpose of illustration only and do not limit the scope of the present disclosure, as exemplary embodiments disclosed herein may provide all or none of the above mentioned advantages and improvements and still fall within the scope of the present disclosure.

Specific dimensions, specific materials, and/or specific shapes disclosed herein are example in nature and do not limit the scope of the present disclosure. The disclosure herein of particular values are not exclusive of other values that may be useful in one or more of the examples disclosed herein.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The term “about” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. For example, the terms “generally,” “about,” and “substantially,” may be used herein to mean within manufacturing tolerances.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the exemplary embodiments.

Spatially relative terms, such as “inner,” “outer,” “beneath,” “below,” “lower,” “above,” “upper,” “left,”, “right” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

With that said, the foregoing description of the embodiments has been provided for purposes of illustration and description. It is not intended to be exhaustive or to limit the disclosure. Individual elements, intended or stated uses, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A link for use in a watch for coupling a watch strap to a base of the watch, the link comprising:
a body defining an arcuate seat extending generally longitudinally along the body;
first and second ears extending generally away from the body, each of the first and second ears defining an opening, the opening of the first ear substantially aligned with the opening of the second ear; and
a channel defined between the first and second ears.

2. The link of claim 1, wherein the body defines opposing first and second longitudinal ends, and wherein the first ear is disposed at the first longitudinal end of the body and the second ear is disposed at the second longitudinal end of the body.

3. The link of claim 1, wherein the first ear further defines an access channel extending generally transverse to a longitudinal axis of the opening of the first ear; and wherein the second ear further defines an access channel extending generally transverse to a longitudinal axis of the opening of the second ear.

4. The link of claim 3, wherein the longitudinal axis of the opening of the first ear generally coincides with the longitudinal axis of the opening of the second ear.

5. The link of claim 1, wherein the first and second ears are integrally formed with the body.

6. The link of claim 5, wherein the body and the first and second ears comprise a metallic material.

7. The link of claim 5, wherein the body and the first and second ears comprise a plastic material.

8. The link of claim 1, wherein a shape of the arcuate seat generally corresponds to an outer circumference of the base of the watch, such that the arcuate seat provides substantially flush contact with the base of the watch when the link is coupled to the watch.

9. The link of claim 8, wherein the channel defined between the first and second ears is configured to receive a portion of the watch strap therein; and wherein the openings of the first and second ears substantially align with an opening defined by the portion of the watch strap received in the channel such that a spring bar can be received through the openings of the first and second ears and the opening of the watch strap for coupling the watch strap to the link.

10. The link of claim 9, wherein the openings of the first and second ears substantially align with openings defined in mounts of the base of the watch when the arcuate seat is positioned in substantially flush contact with the base of the watch generally between the mounts, such that the spring bar extending through the openings of the first and second ears and the opening of the watch strap can also be received in the openings of the mounts to thereby couple the link and the watch strap to the base of the watch.

11. A watch comprising the link of claim 1; the watch further comprising:
the watch strap; and
the base, the base including a face portion configured to indicate a time.

12. A watch strap assembly for a watch, the watch strap assembly comprising:
a watch strap;
a link configured to position at an end portion of the watch strap; and
a spring bar configured to couple the watch strap to the link and the link to a base of the watch.

13. The assembly of claim 12, wherein the link includes:
a body; and
first and second ears extending generally away from the body, the spring bar configured to couple the watch strap to the link generally between the first and second ears.

14. The assembly of claim 13, wherein the first and second ears define openings that substantially align with an opening defined by an end portion of the watch strap positioned between the first and second ears such that the spring bar can be received through the openings of the first and second ears and the opening of the watch strap for coupling the watch strap to the link.

15. The link of claim 14, wherein the first and second ears further define access channels extending generally transverse to longitudinal axes of the openings of the ears, the access channels providing access to the spring bar when the link is coupled to the base of the watch.

16. The assembly of claim 13, wherein the body defines a seat having an arcuate shape that generally corresponds to an outer circumference of the base of the watch such that the seat is positioned generally flush with the base of the watch when the link is coupled to the base of the watch.

17. The assembly of claim 12, wherein the watch strap comprises a leather material.

18. The assembly of claim 12, wherein the watch strap comprises a rubber material.

19. A method of coupling a watch strap to a watch base using a link, the link including a body defining an arcuate seat, and first and second ears extending away from the body, the method comprising:
positioning an end loop of a watch strap between the first and second ears of the link such that a channel defined through the end loop is aligned with openings defined in the first and second ears of the link;
inserting a spring bar through the openings of the first and second ears and through the channel of the end loop to secure the watch strap to the end link; and
positioning a first end of the spring bar in a first depression of the watch base, and a second end of the spring bar in a second depression of the watch base to secure the end link and the watch strap to the watch base.

20. The method of claim 19, further comprising aligning the arcuate seat of the link with a portion of a perimeter of the watch base, such that the seat is substantially flush with the perimeter portion of the watch base.
